(19) United States
(12) Patent Application Publication
(10) Pub. No.: US 2026/0247160 A1
(43) Pub. Date: Aug. 20, 2026

(54) COORDINATION OF RESOURCE SHARING AMONG ACCESS POINTS

(71) Applicant: Telefonaktiebolaget LM Ericsson (publ), Stockholm (SE)

(72) Inventors: Sebastian MAX, Cologne (DE); Charlie PETTERSSON, Solna (SE); Miguel LOPEZ, Solna (SE)

(21) Appl. No.: 19/152,557

(22) PCT Filed: Feb. 13, 2023
(86) PCT No.: PCT/EP2023/053527

§ 371 Date: Jul. 31, 2025

(51) Int. Cl. H04W 16/14; H04W 16/10; H04W 92/20

(52) U.S. Cl. CPC H04W 16/14; H04W 16/10; H04W 92/20

(57) ABSTRACT

A method of a sharing access point (AP) which is included in a set of APs. The APs in the set are connected for direct communication with each other through a wired network. The method is for coordination of resource sharing among the APs in the set according to a resource sharing type. The method includes establishing a resource sharing configuration among the APs in the set by signaling through the wired network, wherein the resource sharing configuration includes a configuration identifier and a configuration parameter. The method also includes transmitting a resource sharing trigger packet by wireless signaling, wherein the resource sharing trigger packet includes the configuration identifier, and wherein the resource sharing trigger packet is configured to provide synchronization in relation to the sharing AP and to initiate a resource sharing session among two or more sharing session APs included in the set of APs.

### TECHNICAL FIELD

The present disclosure relates generally to the field of communication technology. More particularly, it relates to coordination of resource sharing among access points.

### BACKGROUND

Resource sharing among multiple access points (APs) is a concept referred to in association with IEEE 802.11 under the terminology “Multi-AP Coordination”. According to the Multi-AP Coordination concept, communication resources—such as time and/or frequency—that are reserved by a particular AP that has gained channel access may be shared with one or more other APs when the particular AP will not be using all of the reserved resources. To achieve the resource sharing, some coordination among the participating APs is needed; e.g., to determine which resources should be used by which APs.

Some problems and challenges related to IEEE 802.11 Multi-AP Coordination are described in “A perspective on proposed Ultra-High Reliability (UHR) features for enterprise use cases”, by Brian Hart, et al., Cisco Systems, doc.: IEEE 802.11-22/1580r1. Further problems and challenges may also be envisioned.

One problem relates to that coordination information should preferably be conveyed using a robust transmission format (e.g., low-rate modulation and coding scheme, MCS) so that it has a high probability of being correctly conveyed between APs that are relatively far from each other (physically and/or in a signal attenuation sense). The signaling overhead caused by this robust coordination signaling counteracts the efficiency gained by the resource sharing.

One problem relates to deployments where some APs are so far apart that coordination signaling cannot be reliably conveyed; even with a robust transmission format. Then, Multi-AP Coordination is typically not possible among those APs.

One problem relates to deployments with frequency reuse, wherein the APs are grouped in two or more groups and each group uses a respective, dedicated, channel (frequency range). In such deployments, Multi-AP Coordination is typically not possible between groups. Furthermore, at least some of the APs of a group may typically be relatively far from each other, which can make the coordination cumbersome as explained above.

Therefore, there is a need for efficient and reliable approaches to coordination of resource sharing among access points.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method of a sharing access point (AP), which is comprised in a set of APs, wherein the APs in the set are connected for direct communication with each other through a wired network. The method is for coordination of resource sharing among the APs in the set according to a resource sharing type.

The method comprises establishing a resource sharing configuration among the APs in the set by signaling through the wired network, wherein the resource sharing configuration comprises a configuration identifier and a configuration parameter (e.g., one or more configuration parameters), and transmitting a resource sharing trigger packet by wireless signaling, wherein the resource sharing trigger packet comprises the configuration identifier. The resource sharing trigger packet is configured to provide synchronization in relation to the sharing AP and to initiate a resource sharing session among two or more sharing session APs comprised in the set of APs.

In some embodiments, a time duration between start of the signaling through the wired network and start of the wireless signaling is larger than a round-trip-time for signaling through the wired network.

In some embodiments, the resource sharing configuration further comprises the resource sharing type.

In some embodiments, the resource sharing type is defined by one or more of: the sharing session APs using different time portions of a transmission opportunity (TXOP), the sharing session APs using different orthogonal frequency division multiplex (OFDM) sub-carriers, the sharing session APs using different spatial resources, and joint transmission and/or joint reception by the sharing session APs.

In some embodiments, the resource sharing configuration and/or the resource sharing trigger packet further comprises an AP identifier for the sharing AP.

In some embodiments, the configuration parameter indicates an overall communication resource allocation for the resource sharing.

In some embodiments, the configuration parameter indicates a communication resource reservation of the sharing AP.

In some embodiments, the resource sharing trigger packet is further configured to indicate a transmission opportunity (TXOP) duration and/or a network allocation vector (NAV) duration.

In some embodiments, the resource sharing trigger packet has a physical layer protocol data unit (PPDU) format that corresponds to one or more of: a wake-up radio (WUR) PPDU format, a PPDU format with extended preamble and/or decreased coding rate compared to a primary channel bandwidth PPDU format, and a PPDU format for transmission with lower bandwidth than the primary channel bandwidth PPDU.

In some embodiments, establishing a resource sharing configuration comprises establishing a plurality of resource sharing configurations, and the method further comprises selecting one of the established resource sharing configurations. Then, the resource sharing trigger packet comprises the configuration identifier of the selected resource sharing configuration.

In some embodiments, transmitting a resource sharing trigger packet comprises transmitting two or more resource sharing trigger packets to initiate corresponding two or more resource sharing sessions. In some embodiments, each of the two or more resource sharing sessions corresponds to a target wake time (TWT) service period (SP).

In some embodiments, the set of APs comprises a relaying AP, and the resource sharing configuration instructs the relaying AP to re-transmit the resource sharing trigger packet.

In some embodiments, the method further comprises instructing—by signaling through the wired network—one or more measuring AP(s) comprised in the set of APs to perform measurements on a reference packet, transmitting the reference packet by wireless signaling, and receiving respective measurement report(s) from the one or more measuring AP(s), wherein the measurement report(s) are for determination of a wireless signaling routing path, which includes the relaying AP.

A second aspect is a method of an access point (AP), which is comprised in a set of APs, wherein the APs in the set are connected for direct communication with each other through a wired network. The method is for coordination of resource sharing among the APs in the set according to a resource sharing type.

The method comprises establishing a resource sharing configuration among the APs in the set by signaling through the wired network, wherein the resource sharing configuration comprises a configuration identifier and a configuration parameter, and receiving a resource sharing trigger packet by wireless signaling from a sharing AP comprised in the set of APs, wherein the resource sharing trigger packet comprises the configuration identifier. The resource sharing trigger packet is configured to provide synchronization in relation to the sharing AP and to initiate a resource sharing session among two or more sharing session APs comprised in the set of APs. The method also comprises participating—as one of the sharing session APs—in the resource sharing session in accordance with the resource sharing configuration.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for a sharing access point (AP), wherein the sharing AP is configured to be comprised in a set of APs, and wherein the APs in the set are connected for direct communication with each other through a wired network. The apparatus is for coordination of resource sharing among the APs in the set according to a resource sharing type.

The apparatus comprises controlling circuitry configured to cause establishment of a resource sharing configuration among the APs in the set by signaling through the wired network, wherein the resource sharing configuration comprises a configuration identifier and a configuration parameter, and transmission of a resource sharing trigger packet by wireless signaling, wherein the resource sharing trigger packet comprises the configuration identifier. The resource sharing trigger packet is configured to provide synchronization in relation to the sharing AP and to initiate a resource sharing session among two or more sharing session APs comprised in the set of APs.

A fifth aspect is an apparatus for an access point (AP), wherein the AP is configured to be comprised in a set of APs, and wherein the APs in the set are connected for direct communication with each other through a wired network. The apparatus is for coordination of resource sharing among the APs in the set according to a resource sharing type.

The apparatus comprises controlling circuitry configured to cause establishment of a resource sharing configuration among the APs in the set by signaling through the wired network, wherein the resource sharing configuration comprises a configuration identifier and a configuration parameter, and reception of a resource sharing trigger packet by wireless signaling from a sharing AP comprised in the set of APs, wherein the resource sharing trigger packet comprises the configuration identifier. The resource sharing trigger packet is configured to provide synchronization in relation to the sharing AP and to initiate a resource sharing session among two or more sharing session APs comprised in the set of APs. The controlling circuitry is also configured to cause participation—as one of the sharing session APs—in the resource sharing session in accordance with the resource sharing configuration.

A sixth aspect is an access point (AP) comprising the apparatus of any of the fourth and fifth aspects.

A seventh aspect is a communication system comprising a set of access points (APs), wherein the APs in the set are connected for direct communication with each other through a wired network.

The system is adapted for coordination of resource sharing among the APs according to a resource sharing type by establishment of a resource sharing configuration among the APs in the set by signaling through the wired network, wherein the resource sharing configuration comprises a configuration identifier and a configuration parameter, and transmission (by a sharing AP comprised in the set of APs) of a resource sharing trigger packet by wireless signaling, wherein the resource sharing trigger packet comprises the configuration identifier. The resource sharing trigger packet is configured to provide synchronization in relation to the sharing AP and to initiate a resource sharing session among two or more sharing session APs comprised in the set of APs. Furthermore, the system is adapted for coordination of resource sharing among the APs according to a resource sharing type by participation in the resource sharing session (by another AP in the set of APs than the sharing AP)—as one of the sharing session APs—in accordance with the resource sharing configuration and in response to reception of the resource sharing trigger packet.

In some embodiments, any of the above aspects may additionally have features identical with or corresponding to any of the various features as explained above for any of the other aspects.

An advantage of some embodiments is that approaches are provided for coordination of resource sharing among access points.

An advantage of some embodiments is that the coordination is efficient.

An advantage of some embodiments is that the wireless signaling overhead caused by the coordination is reduced compared to other approaches.

An advantage of some embodiments is that the coordination is robust.

An advantage of some embodiments is that the coordination is reliable.

For example, reliable coordination may be achieved even for APs that are relatively far from each other, due to use of signaling through the wired network and/or due to re-transmission of the resource sharing trigger packet by relaying AP(s).

An advantage of some embodiments is that the inherent delay of signaling through the wired network becomes non-problematic due to that the resource sharing trigger packet is transmitted by wireless signaling.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic block diagram illustrating an example communication system according to some embodiments;

FIG. 2 is a schematic drawing illustrating an example communication system scenario according to some embodiments;

FIG. 3 is a flowchart illustrating example method steps according to some embodiments;

FIG. 4 is a flowchart illustrating example method steps according to some embodiments;

FIG. 5 is a signaling diagram illustrating example signaling according to some embodiments;

FIG. 6 is a signaling diagram illustrating example signaling according to the prior art;

FIG. 7 is a signaling diagram illustrating example signaling according to some embodiments;

FIG. 8 is a schematic block diagram illustrating an example apparatus according to some embodiments; and

FIG. 9 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, approaches for coordination of resource sharing among access points (APs) will be described and exemplified.

Generally, it should be noted that, even if the approaches are exemplified in the context of IEEE 802.11 Multi-AP Coordination (e.g., using IEEE 802.11 Multi-AP Coordination terminology), they may be applicable also in other contexts where resource sharing among access points is used. For example, the approaches described herein may be applicable in the context of one or more future communication standards where resource sharing among access points is used, where such standards may, or may not, be under the IEEE 802.11 regime.

The approaches for coordination of resource sharing among access points are applicable for a set of APs when the APs in the set are connected (e.g., operatively connected) for direct communication with each other through a wired network.

For example, that the APs in the set of APs are connected for direct communication with each other through a wired network may imply that there are no access obstacles (e.g., firewalls, or similar) between the APs in the set, and/or that the wired network is a local network (e.g., the communication among the APs through the wired network does not involve communication via some general public communication network, such as the Internet).

An example scenario where a set of APs are connected for direct communication with each other through a wired network is the “enterprise use case” of IEEE 802.11. Some example network deployments that may have a set of APs connected for direct communication with each other through a wired network include deployments in environments such as factories/industries, office spaces, campuses/schools/universities, airports, arenas, shopping centres, city areas, etc.

Typically, Wi-Fi deployments in office spaces and other Wi-Fi deployments relating to the “enterprise use case” differ from a home Wi-Fi deployment in that wireless access should be provided within a physical space that is much larger than a home, and in that channel planning is done by a centrally coordinated entity to ensure low co-channel interference from overlapping basic service sets (BSSs). Hence, a typical “enterprise use case” Wi-Fi deployment uses a frequency reuse factor higher than 1.

Furthermore, all APs in a typical “enterprise use case” Wi-Fi deployment are connected with each other via a wired backbone (e.g., using Ethernet); in contrast to, for example, a collection of home Wi-Fi deployments of an apartment building where the APs of different homeowners are not directly connected to each other. The wired backbone is an example of a wired network, which embodies a connection among APs for direct communication with each other.

The approaches disclosed herein suggest that coordination of resource sharing among APs in the set is achieved by signaling through the wired network to establish a resource sharing configuration among the APs, and using a wireless signaling resource sharing trigger packet to initiate a resource sharing session among two or more APs comprised in the set.

Using signaling through the wired network to establish a resource sharing configuration may entail various advantages. For example, the establishment of the resource sharing configuration becomes reliable and robust, and does not suffer from some APs having relatively weak wireless signaling paths between them (e.g., due to being relatively far away from each other). Furthermore, the establishment of the resource sharing configuration does not entail any wireless signaling overhead.

Typically, information that is required for resource sharing among the APs in the set may be sorted into non-time-critical information and time-critical information. For example, the time-critical information may include all information that needs to be conveyed within a specific time window before the resource sharing session starts, and the non-time-critical information may comprise all information that is not time-critical. In some embodiments, the specific time window may have a duration which is shorter than a round-trip-time for signaling through the wired network. Alternatively or additionally, in some embodiments, the specific time window corresponds to the duration of a short inter-frame spacing (SIFS).

Generally, when a round-trip-time for signaling through the wired network is referred to herein, it may be defined as a maximum (worst case) round-trip-time, an average round-trip-time, or any other suitable round-trip-time value. One example, of a round-trip-time for signaling through the wired network is the medium access control to medium access control (MAC-to-MAC) delay for signaling over an Ethernet connection between two APs.

The signaling through the wired network to establish the resource sharing configuration may include all (or at least some) of the non-time-critical information and none of the time-critical information. The wireless signaling resource sharing trigger packet may comprise at least some of (e.g., all of) the time-critical information (and possibly—but not preferably—some of the non-time-critical information). Thereby, the inherent delay of signaling through the wired network becomes non-problematic.

It should be noted that, according to some embodiments, wireless signaling among the APs may be used also for some coordination signaling other than the resource sharing trigger packet. For example, any reference signaling for performing wireless signaling measurements inherently needs to be transmitted using wireless signaling.

As already mentioned, resource sharing among multiple access points (APs) is a concept referred to in association with IEEE 802.11 under the terminology “Multi-AP Coordination”. Particularly, the topic of “Multi-AP Coordination” has previously been a potential feature for IEEE 802.11be, and gains renewed relevance in relation to the Study Group (SG) on “Ultra High Reliability” (UHR).

Generally, resource sharing among multiple access points (e.g., the Multi-AP Coordination concept) may be defined as including any approach wherein communication resources that are reserved by a particular AP that has gained channel access may be shared with one or more other APs when the particular AP will not be using all of the reserved resources. Alternatively or additionally, resource sharing among multiple access points may be defined as coordinated transmission among two or more APs. In some embodiments, the sharing may be arranged such that the resources used by different APs are orthogonal.

One example of resource sharing among multiple access points comprises “Coordinated Multi-AP Transmission Opportunity (TXOP) Sharing”, wherein a TXOP is reserved for a sharing AP and the sharing AP offers some time portion(s) of the TXOP for use by other APs.

One example of resource sharing among multiple access points comprises “Coordinated Multi-AP OFDMA”, wherein a collection of orthogonal frequency division multiple access (OFDMA) sub-carriers is reserved for a sharing AP and the sharing AP offers some of the reserved sub-carrier(s) for use by other APs.

One example of resource sharing among multiple access points comprises “Coordinated Multi-AP Spatial Reuse”, wherein a sharing AP enables other APs to transmit simultaneously as the sharing AP. For example, the coordination parameter(s) may indicate which transmit power level may be used in each BSS. The transmit power level(s) may be determined under the condition that harmful interference at receivers should be avoided.

One example of resource sharing among multiple access points comprises “Coordinated Multi-AP Beamforming”, wherein a sharing AP offers some spatial resources(s) (e.g., direction(s), beam(s), or similar) for use by other APs.

One example of resource sharing among multiple access points comprises “Coordinated Multi-AP Joint Transmissions/Joint Receptions”, wherein a sharing AP and one or more other AP(s) coordinate their transmissions and/or receptions in relation to a station to provide distributed multiple-input multiple-output (D-MIMO) communication for the station.

Target Wake Time (TWT; including restricted TWT, r-TWT) is an approach wherein future TXOPs are scheduled as so-called service periods (SPs). One example of resource sharing among multiple access points comprises “Coordinated Multi-AP Target Wake Time”, wherein an SP may be seen as a resource sharing session within which a sharing AP offers resources (e.g., time, and/or frequency, and/or spatial resources) for use by other APs.

It should be noted that other examples of resource sharing among multiple access points may be envisioned, as well as combinations of the examples mentioned above.

The term “resource sharing type” may be used to identify a resource sharing principle (according to any of the examples mentioned above, or according to any other suitable resource sharing principle). Thus, “Coordinated Multi-AP Transmission Opportunity (TXOP) Sharing” may be one resource sharing type, “Coordinated Multi-AP OFDMA” may be another resource sharing type, etc.

The coordination of the resource sharing among the APs typically varies depending on the resource sharing type to be applied. For example, the coordination may include exchange of parameters (at least some of which are typically resource sharing type dependent) and synchronization of the Multi-AP operation.

Some of the coordination (e.g., determining which APs are capable of resource sharing with each other, and which resources are to be offered by a sharing AP) may be conducted well in advance of the resource sharing session. The content of such coordination may be seen as part of the non-time-critical information, and may be conveyed through wired signaling between the APs.

Contrarily, some of the coordination (e.g., synchronization in time and/or frequency among the APs) should preferably be conducted just (e.g., a few us-level or even less, while the round-trip-time for signaling through the wired network can be in the order of 1 to 10 milliseconds) before the start of the resource sharing session. The content of such coordination may be seen as part of the time-critical information, and may be conveyed through wireless signaling between the APs.

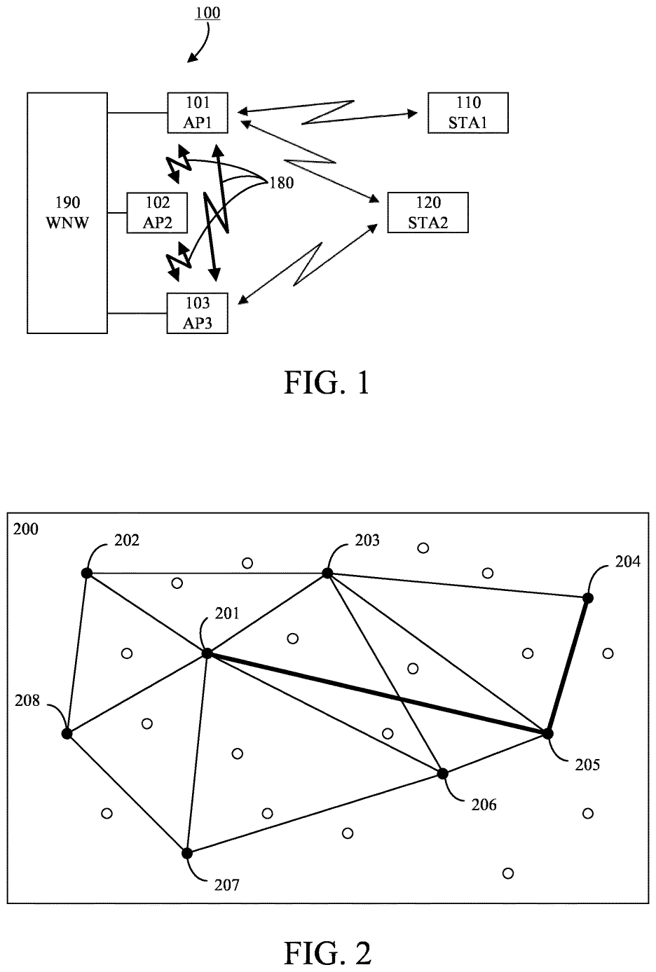

FIG. 1 schematically illustrates an example communication system 100, wherein the suggested approaches for coordination of resource sharing among APs may be applicable. The communication system 100 comprises a set of APs (AP1, AP2, AP3) 101, 102, 103, which are adapted for wireless signaling; e.g., to communicate with one or more stations (STA1, STA2) 110, 120. The APs 101, 102, 103 are also connected for direct communication with each other through a wired network (WNW) 190.

When the suggested approaches for coordination of resource sharing among the APs 101, 102, 103 are applied, signaling through the wired network 190 may be used to establish a resource sharing configuration, while wireless signaling 180 may be used to exchange time-critical information among the APs 101, 102, 103; e.g., convey the resource sharing trigger packet.

FIG. 2 schematically illustrates an example communication scenario comprising a Wi-Fi deployment with frequency reuse in an office space 200. The circles represent APs, whereof the filled circles 201-208 represent APs that share the same frequency channel according to the frequency reuse channel planning. In the wording applied herein, a set of APs for resource sharing may comprise all of the filled circles, or a sub-set thereof.

A line between a pairs of filled circles represent a wireless signaling path between the corresponding APs. It can be seen that some of the APs (e.g., 201 and 204) cannot reach each other directly by wireless signaling. This makes it cumbersome to coordinate resource sharing by wireless signaling.

Furthermore, even if all APs could reach each other directly by wireless signaling, coordination of resource sharing by wireless signaling would entail signaling overhead and would typically require use of a robust (and—therefore—typically time-consuming) transmission format.

These problems may be solved by using wired signaling for the non-time-critical parts of the coordination of resource sharing. The amount of time-critical information, that needs to be carried by wireless signaling (in the resource sharing trigger packet), is rather limited. Thus, the signaling overhead is relatively modest; even if a robust transmission format is used.

For the situation depicted in FIG. 2, where some of the APs cannot reach each other directly by wireless signaling, the resource sharing trigger packet may be repeated by AP(s) that are strategically identified for that purpose. For example, for transmission of a resource sharing trigger packet from AP 201, AP 205 may (during the coordination) be identified as a relaying AP and instructed to re-transmit any resource sharing trigger packet from AP 201 so that it can reach AP 204.

According to the various embodiments that are exemplified herein, a set of APs is a collection of two or more APs that have the potential of sharing resources with each other according to a resource sharing type (e.g., APs associated with a same frequency reuse channel). Furthermore, the APs in the set of APs are connected for direct communication with each other through a wired network as explained herein.

The AP (in the set of APs) that transmits a resource sharing trigger packet for a resource sharing session is denoted “sharing AP”. It should be noted that different resource sharing sessions may be associated with different sharing APs.

One or more other AP(s) (in the set of APs) may participate in a resource sharing session responsive to reception of the corresponding resource sharing trigger packet, and may be denoted as “participating AP(s)”. In some IEEE 802.11 documentation, the participating APs are referred to as “shared APs”. It should be noted that different resource sharing sessions may be associated with different participating APs. For a resource sharing session, the sharing AP and the one or more participating AP(s) are collectively denoted as two or more “sharing session APs”. The sharing session APs may comprise all of the APs in the set of APs, or may comprise only a sub-set of the APs in the set of APs.

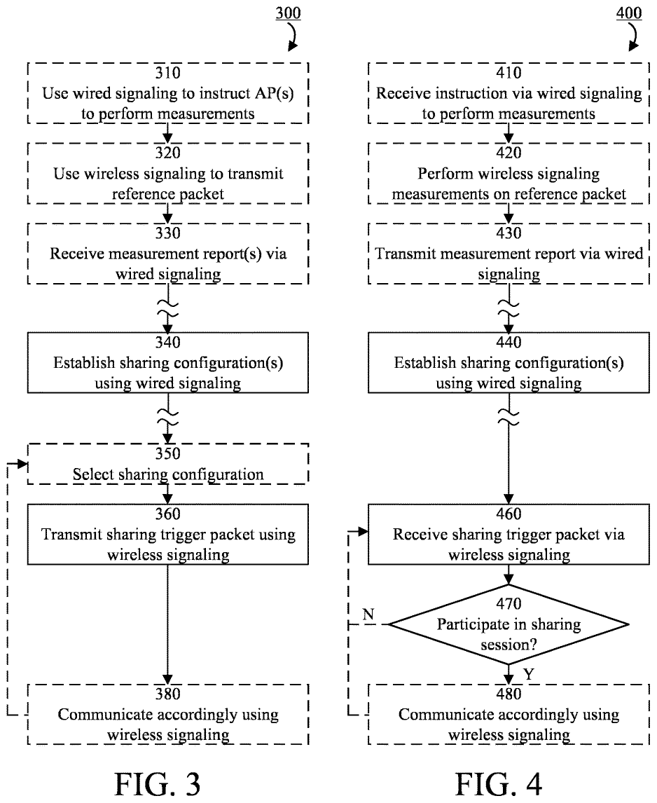

FIG. 3 illustrates an example method 300 for coordination of resource sharing among the APs in a set of APs according to a resource sharing type. The method 300 is for a sharing AP. For example, the method 300 may be performed by a sharing AP (e.g., one of the APs 101, 102, 103 of FIG. 1).

FIG. 4 illustrates an example method 400 for coordination of resource sharing among the APs in a set of APs according to a resource sharing type. The method 400 is for a (potentially) participating AP. For example, the method 400 may be performed by a participating AP (e.g., one or more of the APs 101, 102, 103 of FIG. 1).

The methods 300 and 400 comprises establishing a resource sharing configuration among the APs in the set by signaling through the wired network (e.g., the NWN 190 of FIG. 1), as illustrated by steps 340 and 440.

Typically, the signaling through the wired network for establishing the resource sharing configuration comprises transmission of a configuration message by one AP in the set of APs (e.g., denoted “coordinating AP”), and reception of the configuration message by at least one (typically all) other AP(s) in the set of APs. Corresponding acknowledgement messages may be transmitted by the other AP(s) and received by the coordinating AP. In some embodiments, establishing the resource sharing configuration comprises transmission and reception of several configuration messages (and corresponding acknowledgement messages).

It should be noted that the coordinating AP may be the sharing AP, or a participating AP, or another AP in the set of APs. Similarly, it should be noted that the configuration message may be received by the sharing AP, and/or by a participating AP, and/or by other AP(s) in the set of APs.

The resource sharing configuration comprises a configuration identifier and at least one configuration parameter. The configuration parameter carries non-time-critical information relating to the coordination of resource sharing.

How many, and which, parameters are comprised in the resource sharing configuration typically depends on the resources sharing type to be applied. In some embodiments, the resource sharing configuration further comprises the resource sharing type. In some embodiments, the resource sharing type is implicitly comprised in the resource sharing configuration (e.g., implied by the parameter(s)).

The resource sharing type may be any suitable resource sharing type (e.g., a Multi-AP Coordination scheme). For example, the resource sharing type may be defined by the sharing session APs using different time portions of a TXOP (e.g., “Coordinated Multi-AP TXOP Sharing” and/or “Coordinated Multi-AP Target Wake Time”). Alternatively or additionally, the resource sharing type may be defined by the sharing session APs using different OFDM sub-carriers (e.g., “Coordinated Multi-AP OFDMA” and/or “Coordinated Multi-AP Target Wake Time”). Yet alternatively or additionally, the resource sharing type may be defined by the sharing session APs using different spatial resources (e.g., “Coordinated Multi-AP Beamforming” and/or “Coordinated Multi-AP Target Wake Time”). Yet alternatively or additionally, the resource sharing type may be defined by the sharing session APs using transmit power levels in each BSS that avoid harmful interference at receivers (e.g., “Coordinated Multi-AP Spatial Reuse”). Yet alternatively or additionally, the resource sharing type may be defined by joint transmission and/or joint reception by the sharing session APs (e.g., “Coordinated Multi-AP Joint Transmissions/Joint Receptions”).

Some typical examples of parameters that may be comprised in the resource sharing configuration include (but are not limited to):
AP identities (may be relevant for all resource sharing types),
TXOP duration (may be relevant for all resource sharing types),
maximum transmit power and/or minimum signal-to-noise ratio (SNR) and/or maximum interference level (may be relevant for all resource sharing types),
portions of time to be used by respective APs (may be relevant for resource sharing types where the shared resource is time),
sub-carriers to be used by respective APs (may be relevant for resource sharing types where the shared resource is frequency), and
beams to be used by respective APs and/or null-placement for respective APs (may be relevant for resource sharing types where the shared resource is spatial).

In some embodiments, the configuration parameter(s) indicate an overall communication resource allocation for the resource sharing. The overall communication resource allocation may, for example, define which resources (e.g., time and/or frequency) may be used for communication by any of the APs during the resource sharing session. Examples of overall communication resource allocation include TXOP duration, a collection of one or more resource unit(s) (RU(s)), a frequency bandwidth, a collection of sub-carriers, etc.

Alternatively or additionally, the configuration parameter(s) may indicate a communication resource reservation of the sharing AP. The communication resource reservation of the sharing AP may, for example, define which resources (e.g., time and/or frequency) will be used for communication by the sharing AP during the resource sharing session. Examples of communication resource reservation of the sharing AP include a portion of the TXOP duration, one or more RU(s), a portion of a frequency bandwidth, one or more sub-carrier(s), etc.

Yet alternatively or additionally, the configuration parameter(s) may indicate a communication resource reservation of each potentially participating AP. The communication resource reservation of a potentially participating AP may, for example, define which resources (e.g., time and/or frequency) may be used for communication by the potentially participating AP during the resource sharing session (e.g., a portion of the TXOP duration, one or more RU(s), a portion of a frequency bandwidth, one or more sub-carrier(s), etc.).

In some embodiments, the resource sharing configuration further comprises an AP identifier (e.g., in the form of a MAC address) for the sharing AP.

This may be useful, for example, when the configuration identifier does not uniquely identify the resource sharing configuration among all resource sharing configurations, but rather among the resource sharing configurations of a particular sharing AP. Then, the configuration identifier together with the AP identifier of the sharing AP typically uniquely identifies the resource sharing configuration among all resource sharing configurations.

As illustrated by step 360, the sharing AP transmits a resource sharing trigger packet by wireless signaling (e.g., the wireless signaling 180 of FIG. 1), which is received by the potentially participating AP in step 460.

As illustrated in FIGS. 3 and 4, the transmission/reception of the resource sharing trigger packet may occur at a point in time which is not directly following the establishment of the resource sharing configuration. Typically, a time duration between the start of the signaling through the wired network in steps 340 and 440 and the start of the wireless signaling in steps 360 and 460 is (e.g., substantially) larger than a round-trip-time for signaling through the wired network.

In some embodiments, a plurality of resource sharing configurations (of same or different resource sharing type) are established during execution of steps 340 and 440. Then, the method 300 may comprise selecting one of the established resource sharing configurations, as illustrated by step 350, and the resource sharing trigger packet may comprise the configuration identifier of the selected resource sharing configuration.

The selection of step 350 may, for example, be based on current channel conditions (e.g., signal-to-noise ratio (SNR), signal strength, etc.) and/or communication needs (e.g., BSS-specific load, number of STAs to be served, state of transmission buffers, etc.).

Preferably, the resource sharing trigger packet comprises very little information (to enable use of a robust transmission format and/or to avoid unnecessary signaling overhead). Generally, the resource sharing trigger packet may have any suitable format.

For example, the resource sharing trigger packet may have a PPDU format that corresponds to a wake-up radio (WUR) PPDU format. The WUR PPDU format is robust in terms of modulation (typically on-off keying or frequency shift keying) and enables use of a low coding rate.

Alternatively or additionally, the resource sharing trigger packet may have a PPDU format with time-extended preamble compared to a primary channel bandwidth PPDU format (i.e., a “normal” IEEE 802.11 PPDU), and/or decreased coding rate compared to the normal IEEE 802.11 PPDU format.

Yet alternatively or additionally, the resource sharing trigger packet may have a PPDU format for transmission with lower bandwidth than the primary channel bandwidth PPDU. For example, a single RU may be used for the resource sharing trigger packet transmission. For example, a possible transmission format for the resource sharing trigger packet may consist of only a single small resource unit (e.g., 26 tones/sub-carriers using the High-Efficiency (HE) PHY numerology). Depending on the regulatory limitations, the sharing AP can then increase the transmission power for the resource sharing trigger packet, thereby extending the transmission range.

Thus, since the resource sharing trigger packet payload typically comprises just a few bytes, it is possible to use very robust (possibly specialized) transmission formats for the resource sharing trigger packet, which may also enable a transmission range extension.

At least, the resource sharing trigger packet comprises the configuration identifier. Thereby, the resource sharing trigger packet identifies the resource sharing configuration to be used.

In some embodiments, the resource sharing trigger packet may comprise the AP identifier for the sharing AP.

For example, when a packet (e.g., a PPDU) is configured to include an identity of the transmitter of the packet (e.g., in the form of a MAC address as for IEEE 802.11), this identity of the transmitter may also serve as AP identifier for the sharing AP. Thereby, the AP identifier of the sharing AP may be used together with the configuration identifier to uniquely identify a resource sharing configuration among all resource sharing configurations, and the size of the configuration identifier may be reduced.

Furthermore, the resource sharing trigger packet is configured to provide synchronization (in time and/or frequency) in relation to the sharing AP. This may be accomplished in any suitable way (e.g., by applying known synchronization approaches).

The resource sharing trigger packet may be further configured to indicate (e.g., via a MAC header) a TXOP duration and/or a network allocation vector (NAV) duration. This has the benefit that collision avoidance may be achieved (e.g., by non-scheduled STAs setting their NAV accordingly).

The resource sharing trigger packet is also configured to initiate a resource sharing session among two or more sharing session APs comprised in the set of APs.

Responsive to receiving the resource sharing trigger packet in step 460, the potentially participating AP determines, in step 470, whether or not it will participate, as one of the sharing session APs, in the corresponding resource sharing session in accordance with the resource sharing configuration. When it is determined that the potentially participating AP will not participate in the corresponding resource sharing session (N-path out of 470), the method 400 returns to step 460. When it is determined that the potentially participating AP will participate in the corresponding resource sharing session (Y-path out of 470), the potentially participating AP becomes a participating AP and the method 400 proceeds to step 480.

In steps 380 and 480, the sharing AP and the participating AP (and possibly one or more other participating AP(s)) communicate accordingly with one or more STA(s) using wireless signaling. Thus, the sharing AP and the participating AP (and possibly one or more other participating AP(s)) participate, as sharing session APs, in the corresponding resource sharing session in accordance with the identified resource sharing configuration. When the resource sharing session ends, the methods 300 and 400 returns to steps 360 and 460, respectively.

For example, uplink (UL) communication in steps 380 and 480 may comprise transmission of a basic trigger frame, reception of an UL physical layer protocol data unit (PPDU), and transmission of an acknowledgement, and downlink (DL) communication in steps 380 and 480 may comprise transmission of a DL PPDU, and reception of an acknowledgement.

In some embodiments, two or more resource sharing trigger packets are transmitted (for same or different resource sharing configuration) to initiate corresponding two or more resource sharing sessions. For example, the two or more resource sharing trigger packets may be transmitted at different points in time (e.g., repeatedly, as scheduled, when the sharing AP deems it suitable, etc.).

A particularly useful example in this context is where the two or more resource sharing sessions correspond to target wake time (TWT) service periods (SPs); each resource sharing session corresponding to a respective TWT SP. Thereby, since the resource sharing configuration is determined beforehand, the TWT concept may be applied together with resource sharing.

Thus, the approaches presented herein may be applied to a TWT scheduling scenario, wherein TWT scheduling for delivering low latency sensitive traffic applies to one or more of the APs in the set of APs. The resources of a TWT schedule of one AP may be shared among the APs in the set to enhance the TWT services. Using the establishment of a resource sharing configuration (compare with steps 340 and 440 of FIGS. 3 and 4) as a single setup process for several service periods (SPs), wherein each SP corresponds to a resource sharing session and is triggered by a resource sharing triggering packet (compare with steps 360 and 460 of FIGS. 3 and 4), provides for efficient use of the allotted service periods (SPs). Thus, the amount of signaling overhead required to implement “Coordinated Multi-AP Target Wake Time” is reduced.

According to some embodiments, the resource sharing configuration instructs one or more relaying AP(s) to re-transmit the resource sharing trigger packet. Put differently, the resource sharing configuration may comprise one or more relaying AP identifier(s) (e.g., in the form of MAC address(es)). Thus, when an AP receives a resource sharing trigger packet that identifies a resource sharing configuration where the AP is a relaying AP, that AP re-transmits the resource

This is beneficial when the sharing AP cannot reach some AP(s) directly by wireless signaling and/or when wireless signaling between the sharing AP and some AP(s) cannot be made sufficiently robust. Exemplifying in the context of FIG. 2, the AP 205 may be instructed to act as a relaying AP when the AP 201 is sharing AP, so that the resource sharing trigger packet can reliably reach the AP 204.

To determine which AP(s) should be relaying AP(s) for a particular sharing AP, the following procedure may be applied.

The sharing AP instructs one or more (e.g., all) other AP(s) comprised in the set of APs to perform measurements (e.g., signal strength, SNR, or similar) on a reference packet, as illustrated by steps 310 and 410. The instruction is preferably conveyed by signaling through the wired network. The AP(s) instructed to perform measurements may be denoted “measuring AP(s)”.

The sharing AP transmits the reference packet by wireless signaling, and the measurements are performed by the measuring AP(s), as illustrated by steps 320 and 420.

The sharing AP receives respective measurement report(s) as transmitted from the measuring AP(s), as illustrated by steps 330 and 430. The measurement report(s) should preferably be conveyed by signaling through the wired network.

Based on the measurement report(s), it may be determined whether or not all APs in the set of APs can be reached directly by wireless signaling from the sharing AP. If so, no relaying AP(s) are required for the sharing AP.

If not all APs in the set of APs can be reached directly by wireless signaling from the sharing AP, wireless signaling routing path(s) may be determined from the sharing AP to such un-reachable AP(s), based on the measurement report(s) for the sharing AP and on measurement report(s) relating to other AP(s) action as sharing AP. Any determined routing path includes one or more potential relaying AP, and a suitable one may be selected for inclusion in the resource sharing configuration.

Exemplifying in the context of FIG. 2, the AP 201 may instruct the other APs to perform measurements, transmit a reference packet, and receive the corresponding measurement reports. Based on the reports, it may be concluded that AP 204 is un-reachable by AP 201. To determine routing paths from AP 201 to AP 204, the measurement reports relating to reference packets transmitted from one or more of the APs 202, 203, 205, 206, 207, and 208 may be evaluated. Then it may be found that AP 204 is reachable from AP 203 and from AP 205 (both of which are, in turn, reachable from AP 201). Thus, two routing paths may be determined (201-203-204 and 201-205-204) and either, or both, of the APs 203 and 205 may be identified as relaying APs for resource sharing configurations where AP 201 is sharing AP. For example, AP 203 or AP 205 may be selected as relaying AP based on the signal quality indicated by the respective measurement reports (e.g., the routing path comprising the weakest link may be discarded).

Alternatively or additionally, the resource sharing configuration may indicate how many hops should be applied for re-transmission of the resource sharing trigger packet. For example, it may be indicated by the resource sharing configuration that the resource sharing trigger packet is to be re-transmitted by all APs that received it directly from the sharing AP, while an AP that receives the resource sharing trigger packet via a re-transmission should not re-transmit it (i.e., one hop). A counter may be included in the resource sharing trigger packet to keep track of the number of re-transmission hops that have been performed.

As indicated in FIGS. 3 and 4, the measurement procedure may occur at a point in time which is not directly previous to the establishment of the resource sharing configuration.

It should be noted that, even if not explicitly shown in FIGS. 3 and 4, the measurement procedure (steps 310, 410, 320, 420, 330, 430) may be performed repeatedly and/or in relation to other sharing APs than earlier. Thus, the method 300 may return to step 310 from any of steps 330, 340 and 380, and method 400 may return to step 410 from any of steps 430, 440 and 480.

It should also be noted that, even if not explicitly shown in FIGS. 3 and 4, the establishment of a resource sharing configuration (steps 340, 440) may be performed repeatedly to establish several resource sharing configuration(s). Thus, the method 300 may return to step 340 from any of steps 340 and 380, and method 400 may return to step 440 from any of steps 440 and 480.

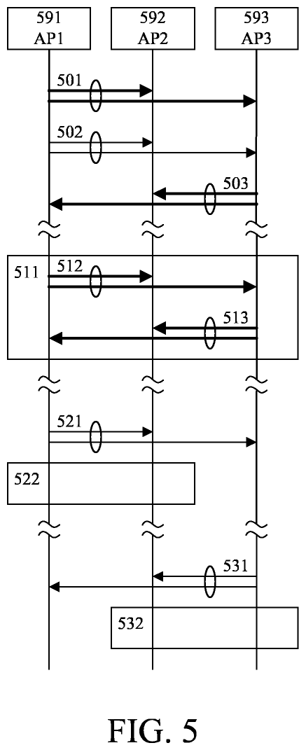

FIG. 5 schematically illustrates example signaling for coordination of resource sharing among the APs in a set of APs according to a resource sharing type. Signaling through the wired network is illustrated by bold arrows.

For example, the signaling illustrated in FIG. 5 may be caused by execution of the method 300 of FIG. 3 and/or by execution of the method 400 of FIG. 4.

In FIG. 5, the set of APs is exemplified as comprising three APs (AP1, AP2, AP3) 591, 592, 593 (compare with the APs 101, 102, 103 of FIG. 1). In practice, the set of APs typically comprises a larger plurality of APs.

A first portion of the signaling in FIG. 5 relates to a procedure for determining which AP(s) should be relaying AP(s) for a particular sharing AP (in this case the AP 591 acts as sharing AP).

In this procedure, the sharing AP 591 instructs—by signaling through the wired network—the other APs 592, 593 comprised in the set of APs to perform measurements on a reference packet, as illustrated by instruction signaling 501 (compare with steps 310 and 410 of FIGS. 3 and 4).

Then, the sharing AP 591 transmits the reference packet by wireless signaling, as illustrated by reference signaling 502, and the measurements are performed by the measuring APs 592, 593 (compare with steps 320 and 420 of FIGS. 3 and 4).

The sharing AP 591 receives—through the wired network—respective measurement reports 503 from the measuring APs 592, 593 (compare with steps 330 and 430 of FIGS. 3 and 4).

Based on the measurement reports 503, it may be determined whether or not all APs in the set of APs can be reached directly by wireless signaling from the sharing AP 591. If, for example, the AP 593 cannot be reached directly by wireless signaling from the sharing AP 591, a relaying AP (e.g., the AP 592) may be identified for re-transmission of resource sharing trigger packets from the sharing AP 591.

A second portion of the signaling in FIG. 5 relates to establishment of one or more resource sharing configuration(s) among the APs 591, 592, 593 by signaling through the wired network, as illustrated by 511 (compare with steps 340 and 440 of FIGS. 3 and 4).

Typically, the signaling for establishment of the resource sharing configuration(s) comprises transmission of a configuration message 512 by a coordinating AP (in this case the AP 591 acts as coordinating AP), and corresponding acknowledgement messages 513 from the other APs.

A third portion of the signaling in FIG. 5 relates to a resource sharing session 522. To initiate the resource sharing session 522, a sharing AP (in this case AP 591) transmits a resource sharing trigger packet 521 by wireless signaling to the potentially participating APs 592, 593 (compare with steps 360 and 460 of FIGS. 3 and 4).

If the configuration identified by the resource sharing trigger packet 521 so instructs, the resource sharing trigger packet 521 is re-transmitted by the relaying AP(s).

One or more of the potentially participating APs (in this case the AP 592) may decide to participate in the resource sharing session 522 and thereby become a participating AP (compare with step 470 of FIG. 4).

Then, during the resource sharing session 522, the sharing session APs (i.e., the sharing AP 591 and the participating AP 592) uses wireless signaling to communicate with one or more STA(s) while sharing resources according to the identified resource sharing configuration (compare with steps 380 and 480 of FIGS. 3 and 4).

A fourth portion of the signaling in FIG. 5 relates to another resource sharing session 532. To initiate the resource sharing session 532, a sharing AP (in this case AP 593) transmits a resource sharing trigger packet 531 by wireless signaling to the potentially participating APs 591, 592 (compare with steps 360 and 460 of FIGS. 3 and 4).

If the configuration identified by the resource sharing trigger packet 531 so instructs, the resource sharing trigger packet 531 is re-transmitted by the relaying AP(s).

One or more of the potentially participating APs (in this case the AP 592) may decide to participate in the resource sharing session 532 and thereby become a participating AP (compare with step 470 of FIG. 4).

Then, during the resource sharing session 532, the sharing session APs (i.e., the sharing AP 593 and the participating AP 592) uses wireless signaling to communicate with one or more STA(s) while sharing resources according to the identified resource sharing configuration (compare with steps 380 and 480 of FIGS. 3 and 4).

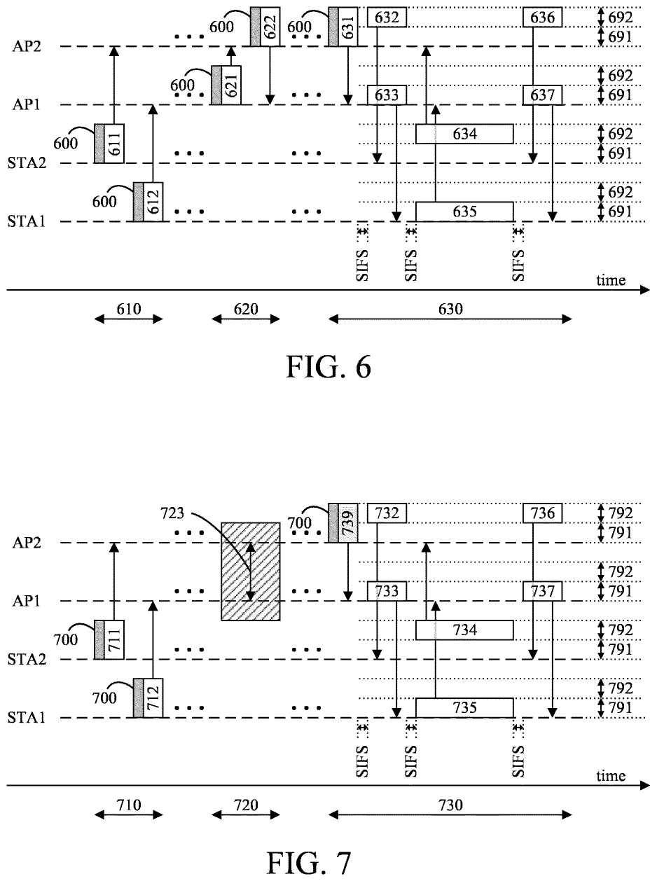

The signaling diagrams of FIGS. 6 and 7 illustrate, by means of a “Coordinated Multi-AP OFDMA” example, differences between coordination of resource sharing according to the prior art (FIG. 6) and coordination of resource sharing according to some embodiments of the suggested approach (FIG. 7). The process of channel acquisition (e.g., winning the contention in accordance with the IEEE 802.11 backoff procedure) is indicated by grey blocks 600, 700 in FIGS. 6 and 7.

The “Coordinated Multi-AP OFDMA” example relates to UL communication from a station (STA2) to a sharing access point (AP2) and UL communication from a station (STA1) to a participating access point (AP1). In this example, the sharing access point AP2 only reserves an upper part 692, 792 of the available bandwidth for communication between STA2 and AP2, and offers a lower part 691, 791 of the available bandwidth for communication between STA1 and AP1 (e.g., the sharing access point AP2 permits usage of certain Resource Units (RUs) by the participating access point(s) AP1 for communication within the respective BSS(s)).

In a first phase 610, 710, the stations STA1, STA2 transmits respective measurements frames 611, 612, 711, 712 to the access points AP1, AP2. Thereby, preferred frequency resources may be identified for each of the communication pairs STA1-AP1 and STA2-AP2.

In a second phase 620, 720, the access points AP1, AP2 exchanges information regarding the preferred frequency resources as preparation for resource sharing.

According to the prior art, this information exchange is implemented by wireless transmission of AP-to-AP frames 621, 622, which causes wireless signaling overhead. Furthermore, the AP-to-AP frames 621, 622 typically need to use a robust transmission format, and there is a risk that the AP-to-AP frames 621, 622 cannot be reliably conveyed when the wireless signaling conditions between AP1 and AP2 are poor.

According to some embodiments, this information exchange is implemented by signaling 723 through the wired network, which constitutes reliable conveyance and does not cause any wireless signaling overhead.

To exemplify the signaling 723, AP2 may first announce the resource sharing type (“Coordinated Multi-AP OFDMA”), together with its wireless MAC address and a configuration identifier (e.g., a randomly selected number). Then, AP2 may announce that it intends to use the upper half 792 of the frequency spectrum for a triggered uplink transmission within its BSS, but intends to leave the lower half 791 available for other AP(s). Receiving this information, AP1 may reply by indicating that it will join the coordinated transmission of the resource sharing session, and use the entire lower half 791 of the frequency spectrum. This may be followed by an acknowledgement from AP. Thus, all required parameters are exchanged between the APs using signaling through the wired network; except the point in time for starting the resource sharing session is left open.

The first and second phases may be seen as pre-TXOP setup phases, and the information exchange is not subject to any tight timing requirements.

It should be noted that the signaling 723 may, generally, comprise any suitable non-time-critical information to be used for coordination of the resource sharing session.

In a third phase 630, 730, which corresponds to a sharing session for the TXOP, the resources are shared as agreed. Thus, the communication between AP2 and STA2 uses only the upper part 692, 762 of the available bandwidth (wherein AP2 sends a basic trigger frame 632, 732 to STA2; STA2 sends an UL PPDU 634, 734 to AP2; and AP2 sends an acknowledgement frame 636, 736 to STA2), and the communication between AP1 and STA1 uses only the lower part 691, 791 of the available bandwidth (wherein AP1 sends a basic trigger frame 633, 733 to STA1; STA1 sends an UL PPDU 635, 735 to AP1; and AP1 sends an acknowledgement frame 637, 737 to STA1).

According to the prior art, the resource sharing session is initiated by AP2 transmitting a Multi-AP trigger frame 631 to AP1. The Multi-AP trigger frame 631 represents the synchronization point for the following operation, and typically also comprises information relating to the resource sharing session (e.g., all parameters for the upcoming transmissions).

According to some embodiments, the resource sharing session is initiated by AP2 transmitting a resource sharing trigger packet 739 to AP1. When AP1 receives the resource sharing trigger packet 739, it may determine (e.g., based on the MAC address of the sender (AP2) and/or the configuration identifier) which established resource sharing configuration to use for the initiated resource sharing session. The resource sharing trigger packet 739 also provides synchronization for the resource sharing session, but typically comprises very little information (e.g., only time-critical information relating to the resource sharing session; the non-time-critical information may be previously conveyed in the information exchange implemented by signaling 723 through the wired network). Thereby, the triggering of the resource sharing session may be implemented using a robust transmission format and/or may entail less signaling overhead than in the prior art approaches.

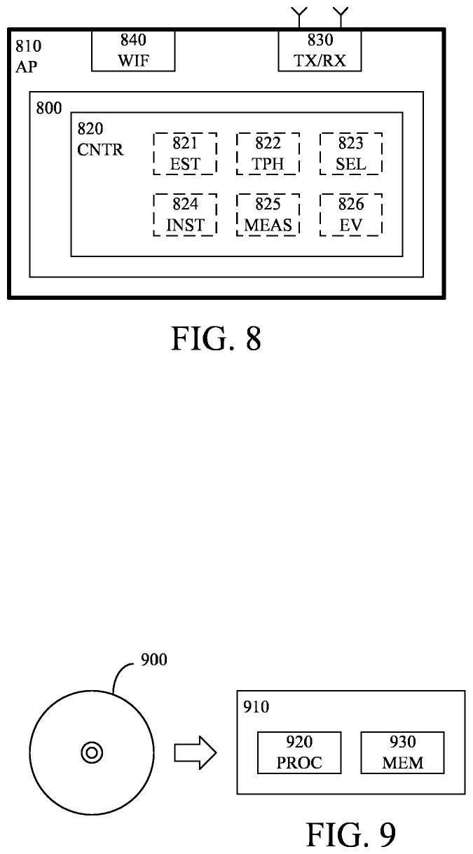

FIG. 8 schematically illustrates an example apparatus 800 according to some embodiments. The apparatus 800 is for (e.g., comprised, or comprisable, in) an access point (AP) 810. The AP 810 is configured to be comprised in a set of APs, and the apparatus 800 is for coordination of resource sharing among the APs in the set according to a resource sharing type.

To this end, the APs in the set are connected for direct communication with each other through a wired network (e.g., via a wired interface (WIF) 840 of each AP), and the APs in the set are configured for wireless communication (e.g., using a wireless transceiver (TX/RX) 830 of each AP).

Generally, the AP 810 can take any suitable role(s) as described herein. For example, the AP 810 may be configured to act as one or more of: a sharing AP, a potentially participating AP, a participating AP, a sharing session AP, a coordinating AP, a measuring AP, and a relaying AP.

In some embodiments, the apparatus 800 may be adapted to be comprised in one of the APs 101, 102, 103 of FIG. 1 and/or in one of the APs 591, 592, 593 of FIG. 1. Alternatively or additionally, the apparatus 800 may be configured to cause performance of (e.g., configured to perform) one or more method steps as described in connection with FIGS. 3 and 4.

The apparatus 800 comprises a controller (CNTR; e.g., controlling circuitry or a control module) 820.

The controller 820 is configured to cause establishment of one or more resource sharing configuration(s) among the APs in the set by signaling through the wired network (compare with steps 340 and 440 of FIGS. 3 and 4).

To this end, the controller 820 may comprise, or be otherwise associated with (e.g., connected, or connectable, to) a resource sharing configuration establisher (EST; e.g., establishing circuitry or an establishment module) 821. The establisher 821 may be configured to use the wired interface 840 to establish the resource sharing configuration(s) in collaboration with the other APs of the set of APs.

The controller 820 is also configured to cause transmission/reception of a resource sharing trigger packet by wireless signaling (compare with steps 360 and 460 of FIGS. 3 and 4).

To this end, the controller 820 may comprise, or be otherwise associated with (e.g., connected, or connectable, to) a resource sharing trigger packet handler (TPH; e.g., handling circuitry or a handling module) 822.

The handler 822 may be configured to generate the resource sharing trigger packet for transmission via the transceiver 830. When there are several established resource sharing configurations, the controller 820 may be configured to cause selection of one of the established resource sharing configurations (compare with step 350 of FIG. 3), and the resource sharing trigger packet comprises the configuration identifier of the selected resource sharing configuration. To this end, the controller 820 may comprise, or be otherwise associated with (e.g., connected, or connectable, to) a resource sharing configuration selector (SEL; e.g., selecting circuitry or a selection module) 823.

Alternatively or additionally, the handler 822 may be configured to process the resource sharing trigger packet as received via the transceiver 830. Processing of a received resource sharing trigger packet may, for example, comprise determining whether or not the AP 810 is to participate in the resource sharing session initiated by the resource sharing trigger packet (compare with step 470 of FIG. 4). Processing of a received resource sharing trigger packet may, alternatively or additionally, comprise re-transmitting the received resource sharing trigger packet when the AP 810 acts as a relaying AP.

The controller 820 is also configured to cause participation, as a sharing session AP, in the resource sharing session initiated by the transmitted/received resource sharing trigger packet and in accordance with the resource sharing configuration (compare with steps 380 and 480 of FIGS. 3 and 4).

In some embodiments, the controller 820 may be configured to cause instruction, by signaling through the wired network, of measuring AP(s) to perform measurements on a reference packet and transmission of the reference packet by wireless signaling (compare with steps 310 and 320 of FIG. 3). The controller 820 may also be configured to cause reception of respective measurement report(s) from the measuring AP(s) (compare with step 330 of FIG. 3).

To this end, the controller 820 may comprise, or be otherwise associated with (e.g., connected, or connectable, to) an instructor (INST; e.g., instructing circuitry or an instruction module) 824. The instructor 824 may be configured to generate an instruction message for transmission via the wired interface 840, trigger transmission of a reference packet via the transceiver 830, and monitor reception of the measurement report(s) via the wired interface 840.

Alternatively or additionally, the controller 820 may be configured to cause—responsive to being instructed by signaling through the wired network—measurements to be performed on a reference packet received via the transceiver 830 (compare with steps 410 and 420 of FIG. 4).

The controller 820 may also be configured to cause transmission of a measurement report (compare with step 430 of FIG. 4).

To this end, the controller 820 may comprise, or be otherwise associated with (e.g., connected, or connectable, to) a measurer (MEAS; e.g., measuring circuitry or a measurement module) 825. The measurer 825 may be configured to perform measurements on a reference packet received via the transceiver 830 responsive to reception of an instruction message via the wired interface 840, and to generate a measurement report for transmission via the wired interface 840.

The measurement report(s) are for determination of a wireless signaling routing path, which includes a relaying AP. In some embodiments, the controller 820 may be configured to cause evaluation of measurement reports to determine a routing path and/or a relaying AP.

To this end, the controller 820 may comprise, or be otherwise associated with (e.g., connected, or connectable, to) an evaluator (EV; e.g., evaluating circuitry or an evaluation module) 826. The evaluator 826 may be configured to evaluate measurement reports to determine a routing path and/or a relaying AP.

Generally, it should be noted that features and/or advantages that are described and/or exemplified in connection with one of the Figures herein may be equally applicable—mutatis mutandis—in the context of one or more of the other Figures; even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as an access point.

Embodiments may appear within an electronic apparatus (such as an access point) comprising arrangements, circuitry, and/or logic according to any of the embodiments described herein.

Alternatively or additionally, an electronic apparatus (such as an access point) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 9 illustrates an example computer readable medium in the form of a compact disc (CD) ROM 900. The computer readable medium has stored thereon a computer program comprising program instructions. The computer program is loadable into a data processor (PROC; e.g., a data processing unit) 920, which may, for example, be comprised in an access point 910. When loaded into the data processor, the computer program may be stored in a memory (MEM) 930 associated with, or comprised in, the data processor. According to some embodiments, the computer program may, when loaded into, and run by, the data processor, cause execution of method steps and/or signaling according to, for example, any of the examples illustrated in FIGS. 3, 4, and 5, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method of a sharing access point, AP, which is comprised in a set of APs, for coordination of resource sharing among the APs in the set according to a resource sharing type, the APs in the set being connected for direct communication with each other through a wired network, the method comprising:
establishing a resource sharing configuration among the APs in the set by signaling through the wired network, the resource sharing configuration comprising a configuration identifier and a configuration parameter; and
transmitting a resource sharing trigger packet by wireless signaling, the resource sharing trigger packet comprising the configuration identifier, and the resource sharing trigger packet being configured to provide synchronization in relation to the sharing AP and to initiate a resource sharing session among two or more sharing session APs comprised in the set of APs.

2. The method of claim 1, wherein a time duration between start of the signaling through the wired network and start of the wireless signaling is larger than a round-trip-time for signaling through the wired network.

3. The method of claim 1, wherein the resource sharing configuration further comprises the resource sharing type.

4. The method of claim 1, wherein the resource sharing type is defined by one or more of:
the sharing session APs using different time portions of a transmission opportunity, TXOP;
the sharing session APs using different orthogonal frequency division multiplex, OFDM, sub-carriers;
the sharing session APs using different spatial resources; and
one or both joint transmission and joint reception by the sharing session APs.

5. The method of claim 1, wherein the resource sharing configuration further comprises an AP identifier for the sharing AP, and wherein the resource sharing trigger packet further comprises the AP identifier for the sharing AP.

6. The method of claim 1, wherein the configuration parameter indicates an overall communication resource allocation for the resource sharing.

7. The method of claim 1, wherein the configuration parameter indicates a communication resource reservation of the sharing AP.

8. The method of claim 1, wherein the resource sharing trigger packet is further configured to indicate one or more of a transmission opportunity, TXOP, duration and a network allocation vector, NAV, duration.

9. (canceled)

10. (canceled)

11. The method of claim 1, wherein transmitting a resource sharing trigger packet comprises transmitting two or more resource sharing trigger packets to initiate corresponding two or more resource sharing sessions.

12.-14. (canceled)

15. A method of an access point, AP, which is comprised in a set of APs, for coordination of resource sharing among the APs in the set according to a resource sharing type, the APs in the set being connected for direct communication with each other through a wired network, the method comprising:
establishing a resource sharing configuration among the APs in the set by signaling through the wired network, the resource sharing configuration comprising a configuration identifier and a configuration parameter;
receiving a resource sharing trigger packet by wireless signaling from a sharing AP comprised in the set of APs, the resource sharing trigger packet comprising the configuration identifier, and the resource sharing trigger packet being configured to provide synchronization in relation to the sharing AP and to initiate a resource sharing session among two or more sharing session APs comprised in the set of APs; and
participating, as one of the sharing session APs, in the resource sharing session in accordance with the resource sharing configuration.

16. (canceled)

17. An apparatus for a sharing access point, AP, the sharing AP being configured to be comprised in a set of APs, the APs in the set being connected for direct communication with each other through a wired network, the apparatus being for coordination of resource sharing among the APs in the set according to a resource sharing type, and the apparatus comprising controlling circuitry configured to cause:
establishment of a resource sharing configuration among the APs in the set by signaling through the wired network, the resource sharing configuration comprising a configuration identifier and a configuration parameter; and
transmission of a resource sharing trigger packet by wireless signaling, the resource sharing trigger packet comprising the configuration identifier, and the resource sharing trigger packet being configured to provide synchronization in relation to the sharing AP and to initiate a resource sharing session among two or more sharing session APs comprised in the set of APs.

18. The apparatus of claim 17, wherein the controlling circuitry is further configured to cause a time duration between start of the signaling through the wired network and start of the wireless signaling to be larger than a round-trip-time for signaling through the wired network.

19. The apparatus of claim 17, wherein the resource sharing configuration further comprises the resource sharing type.

20. The apparatus of claim 17, wherein the resource sharing type is defined by one or more of:
the sharing session APs using different time portions of a transmission opportunity, TXOP;
the sharing session APs using different orthogonal frequency division multiplex, OFDM, sub-carriers;
the sharing session APs using different spatial resources; and
one or both joint transmission and joint reception by the sharing session APs.

21. The apparatus of claim 17, wherein one or both:
the resource sharing configuration further comprises an AP identifier for the sharing AP; and
the resource sharing trigger packet further comprises the AP identifier for the sharing AP.

22. The apparatus of claim 17, wherein the configuration parameter indicates an overall communication resource allocation for the resource sharing.

23. The apparatus of claim 17, wherein the configuration parameter indicates a communication resource reservation of the sharing AP.

24. The apparatus of claim 17, wherein the resource sharing trigger packet is further configured to indicate one or both of a transmission opportunity, TXOP, duration and a network allocation vector, NAV, duration.

25. (canceled)

26. (canceled)

27. The apparatus of claim 17, wherein the controlling circuitry is configured to cause transmission of a resource sharing trigger packet by causing transmission of two or more resource sharing trigger packets to initiate corresponding two or more resource sharing sessions.

28.-30. (canceled)

31. An apparatus for an access point, AP, wherein the AP is configured to be comprised in a set of APs, the APs in the set being connected for direct communication with each other through a wired network, the apparatus being for coordination of resource sharing among the APs in the set according to a resource sharing type, and the apparatus comprising controlling circuitry configured to cause:
establishment of a resource sharing configuration among the APs in the set by signaling through the wired network, the resource sharing configuration comprising a configuration identifier and a configuration parameter;
reception of a resource sharing trigger packet by wireless signaling from a sharing AP comprised in the set of APs, the resource sharing trigger packet comprising the configuration identifier, and the resource sharing trigger packet being configured to provide synchronization in relation to the sharing AP and to initiate a resource sharing session among two or more sharing session APs comprised in the set of APs; and
participation, as one of the sharing session APs, in the resource sharing session in accordance with the resource sharing configuration.

32. (canceled)

33. (canceled)
